(19) United States
(12) Patent Application Publication
(10) Pub. No.: US 2015/0058480 A1
(43) Pub. Date: Feb. 26, 2015

(54) Measuring Instrument Access Apparatus, Field Device, and Method for Controlling the Access to a Measuring Instrument

(71) Applicant: VEGA Grieshaber KG, Wolfach (DE)

(72) Inventors: Volker Allgaier, Haslach i.k (DE); Holger Staiger, Hardt (DE)

(21) Appl. No.: 14/463,364

(22) Filed: Aug. 19, 2014

(30) Foreign Application Priority Data
Aug. 20, 2013 (DE) 10 2013 216 501.3

(51) Int. Cl. H04L 12/26

(52) U.S. Cl. CPC H04L 43/10
USPC 709/224

(57) ABSTRACT

A measuring instrument access apparatus receives a data packet for a field device unit and extracts external addressing information and instruction information. The measuring instrument access apparatus forwards the extracted information to a management device. The management device translates a field device feature from the external addressing information into internal addressing information of the field device unit and forwards a request to the field device unit.

### REFERENCE TO RELATED APPLICATIONS

This application claims the benefit of the filing date of German Patent Application Serial No. 10 2013 216 501.3 filed on 20 Aug. 2013, the disclosure of which is hereby incorporated herein by reference.

### TECHNICAL FIELD

The present invention relates to the technical field of measurement technology. In particular, the present invention relates to a measuring instrument access apparatus, a method for controlling the access to a measuring instrument, a field device, and a switching center.

### BACKGROUND INFORMATION

There are field devices capable of accessing the Internet that have packet-oriented interfaces to permit the most flexible access possible to said field devices in packet networks. The field devices are also increasingly commonly equipped with wireless transmission technologies or radio transmission technologies in order to further increase the flexibility of connecting to transmission networks. Field devices that use wireless technologies are referred to as wireless field devices and utilize wireless data transmission technologies, such as, for example, UMTS (Universal Mobile Telecommunications System), GPRS (General Packet Radio Service), HSDPA (High Speed Downlink Packet Access), LTE (Long Term Evolution) or WLAN (Wireless Local Area Network). Wireless technology or radio technology make it possible to communicate with a field device, issue commands to this field device, or also query measurement results from the field device over a transmission link. These field devices, in particular wireless field devices, usually independently establish connections to other systems. The field devices are set up such that said field devices can establish connections to other systems or receivers on the basis of various rules, in order to exchange the desired data with said other systems or receivers. The rules can be set and can be adapted in any manner.

The connections to other systems can be connections to servers of any type. The wireless field devices can establish a connection, for example, to a mail server, to a database server, or to a FTP (File Transfer Protocol) server. The receiver and the field device are connected to a network in order to enable a connection to be established to the receiver. This network can be a public network, for example the Internet, the public fixed network, or the public mobile radio network, or also a corresponding private network.

There may be a need, however, to access terminal equipment more efficiently.

### SUMMARY OF THE INVENTION

The invention is described by the features of the independent claims. Developments of the invention are specified in the dependent claims.

According thereto, a measuring instrument access apparatus, a method for controlling the access to a measuring instrument, a field device, and a switching center also referred to as a switching center device are described.

According to one aspect of the present invention, a measuring instrument access apparatus is described. The measuring instrument access apparatus substantially controls the access to field devices that are located on a substantially private or internal network. The measuring instrument access apparatus has an external data interface, in order to connect the measuring instrument access apparatus to a public network. In one example, the public network is a public data network, for example the Internet, or a public voice network. The measuring instrument access apparatus further comprises an internal data interface in order to connect to a private network. In addition, the measuring instrument access apparatus comprises a database, a management device, and a switching device. The management device is also referred to as an administration device.

The external data interface is adapted to receive a data packet and extract, from the received data packet or data package, external addressing information and instruction information, which was sent with the packet or was entered via an input mask, and to forward the extracted information to the management device. The instruction information may also be referred to as a command information. In one example, the external data interface and/or the internal data interface is a MAU (Medium Attachment Unit) that has a protocol stack. An internal network comprising a management device, which organizes the access by the field devices to the private network, may also be referred to as an internal database.

The management device is adapted to extract a field device feature of a field device unit, of a measuring instrument or of a sensor connected to the internal data interface, said field device feature being extracted from the external addressing information. The management device is further adapted to check, by querying the database, whether the instruction information is supposed to be or is allowed to be forwarded to the field device unit that is connected to the internal data interface. The management device is further adapted to translate the field device feature into internal addressing information of the field device unit. The field device feature is a fixed identifier or a permanent identifier of the connected field device unit, which identifier is substantially associated with the field device unit and enables the connected field device unit to be distinguished from other field device units. The field device feature may be substantially invariably associated with the field device unit, the sensor, or the measuring instrument. The field device feature may be “burned into” the field device, i.e., may be stored in a firmware of the field device unit or stored in a permanent or special register of the field device unit, at a standardized place or in a specified address area of a memory of the field device unit. The field device feature can be a permanent field device feature, such as, for example, a serial number that had been substantially invariably assigned to the field device unit in the production process. The field device feature may also be a network feature, however, such as an IMEI (International Mobile Station Equipment Identity), which is not assigned to the field device for as long as a field device feature, but which is assigned in a substantially quasi-permanent manner. In one example, the field device feature and the network feature may be assigned to the field device for a longer period as compared to internal addressing information. The field device feature and/or the network feature may therefore be used as a substantially unique identifier for the field device unit, while addressing information only temporarily identifies a field device unit.

In one example it may be possible to query the field device feature from the field device unit by means of specific commands of a field device bus, for example, by means of a command from the HART protocol, such as an upload or a download, by means of a Profibus protocol, such as a physical block, a transducer block, or a function block or by means of a Fieldbus Foundation protocol. The field device feature can also be queried, however, by means of a command in a device description language or from a user interface, for example by means of DDL (Device Description Language), DTM (Device Type Manager), FDT (Field Device Type), EDDL (Enhanced DDL). In another example, it may be possible to query the field device feature via an alphanumeric or graphic display, for example via a certain key combination. In yet another example, only a plurality or a limited plurality of field device features is permitted, and therefore the management device substantially only needs to search for a certain format of the field device feature in the external addressing information when extracting the field device feature.

The field device feature or the permanent identifier makes it possible to distinguish the connected field device unit from other field device units. This distinction may take place at a layer other than the network layer. The internal addressing information of the field device unit may be an identifier or an identifier for the location at which the field device unit is located at the internal data interface, or an identifier that may be used to access the field device unit in a communication network. The internal addressing information may characterize the field device unit at a network layer of the OSI model. The internal addressing information or the identifier for the location may be assigned temporarily. That is, the internal addressing information may be assigned to the field device substantially only for a certain time range, for example, for the time during which the field device is in use. Therefore, the internal addressing information may not be invariably associated with the field device unit.

The switching device is adapted to forward, to the field device unit, the instruction information that is supposed to be or is allowed to be forwarded to the field device unit via the internal data interface by means of the internal addressing information of the field device unit. The instruction information may be forwarded by using internal addressing information of the field device. The switching device may also be referred to as a coupling device. The field device unit is connected to the internal data interface.

The temporary assignment of the identifier may mean that, for example, the identifier is assigned to the field device unit only for as long as the field device unit is connected to the internal network or the private network.

According to another aspect of the present invention, a method for controlling the access to a measuring instrument or a field device unit is described, said method comprising the receipt of a data packet or a data package via an external data interface. The method for controlling the access to a measuring instrument further comprises the extraction of external addressing information, for example, from an external data packet received from an external network or a public network. The method also comprises the extraction of instruction information that may be contained in the data packet that was received. Moreover, the method comprises the extraction of a field device feature of a field device unit connected to an internal data interface, wherein the field device feature may be derived from the ascertained or determined external addressing information.

A database may then be queried in order to check whether the instruction information should be or is allowed to be forwarded to the field device unit that is connected to the internal data interface. In order to determine whether the instruction information is supposed to be forwarded to the field device unit, it may be determined, for example by means of a measuring instrument access apparatus, whether a field device unit that belongs to the extracted addressing information, in particular to the extracted field device feature, is present in the private network.

It may be further provided in the method for controlling the access to a measuring instrument that the field device feature that has been extracted from the received data packet is translated into internal addressing information of the field device unit. Converting the field device feature into the internal addressing information may make it possible to characterize the field device within the private network, and it may be possible to reach and access or address the field device unit in the private network by means of this addressing information.

The instruction information is recognized. It is further recognized that the instruction information should be forwarded to the field device unit. The instruction information may be forwarded to the field device unit that is connected to the internal data interface, via the internal data interface by means of the internal addressing information of the field device unit.

The field device feature is a permanent identifier of the connected field device unit, which identifier is associated with the field device unit and enables the connected field device unit to be distinguished from other field device units that are also connected to the private network and/or the internal data interface. The internal addressing information of the field device unit is substantially an identifier for the location at which the field device unit is located at the internal data interface and, in particular, at which location the field device unit is connected to the internal data interface. This address information is used to distinguish the field device unit from other field device units within the internal data network. The identifier of the location of the field device unit or the internal addressing information for the field device unit is temporarily assigned and is only temporarily assigned, for example, for the time during which the field device unit can be reached in the network.

In this manner, a field device feature may be converted into current addressing information in the internal network such that the field device unit can be accessed, addressed and/or reached from a public network merely by extracting at least one of the field device features of the field device unit from an external address, wherein the field device feature is specifically assigned to the field device unit and by assigning the at least one field device feature to an internal address.

In one example, the external addressing information, in particular a field device feature derived therefrom, may be assigned at least to one of the layers 5-7 of the OSI reference model (Open Systems Interconnection Model), while the internal addressing information may be assigned to layer 3 or lower. The field device feature may be evaluated at one of the layers 5-7 and, in particular, at layer 7, the application layer. A switching center device may operate at the network layer and, therefore, substantially evaluate parameters of layer 3 and below layer 3. The network features may be evaluated at layer 3, the network layer. The evaluation of the features or addressing information may be carried out by protocols that are assigned to the respective layer.

The field device feature may not be usable directly for routing purposes and may not have a hierarchical structure, such as a domain name.

According to yet another aspect of the present invention, a field device unit or a field device is described, wherein the field device unit comprises a field device feature carrier device, a network feature carrier device and a controller or a processor. The controller may also be referred to as a controlling device. The field device feature carrier device may also be referred to as a field device feature carrier unit. The network feature carrier device may also be referred to as a network feature carrier unit. The field device feature carrier device may be a device that assigns a substantially invariable field device feature to a field device, a field device unit, a measuring instrument, or a sensor. The field device feature carrier device may be substantially permanently associated with the field device, being “burned into” the field device, or, for example, permanently stored in a firmware of the field device or in a register of a memory of the field device unit. A serial number or a production number of the field device may be used as the field device feature that is stored on the field device feature carrier device.

The network feature carrier device may be an identifier of the field device unit within a data network. The network feature carrier device may be temporarily assigned to a field device by temporarily installing the network feature carrier device in or on the field device, for example. The network feature carrier device may be detachable or pluggable in order to permit temporary installation. For example, a SIM card of a mobile network operator, as the network feature carrier device, can be assigned to a field device. In another example, a radio unit or a radio device may also be assigned to the field device, for example a GSM unit, and an IMEI may be assigned to the field device, in particular to the radio unit.

A SIM card has at least one network feature. The network feature may be linked to an internal address by the network or a component of the network. A network feature that is stored on a network feature carrier device may be an IMEI or an ICCID (Integrated Circuit Card Identifier). A network feature may not allow the location of a field device within a network to be determined, however, but rather merely provide an individual and unique identifier within a network. In other words, the location of a field device within a network may not be directly determined from the network feature.

The field device unit may further comprise a communication device, which is adapted to communicate with a data network and, for example, supports the protocols of the data network.

The controlling device is adapted to detect the switching-on of a field device. A switching-on of a field device may be detected, for example, by virtue of the fact that a voltage supply or a power supply is connected to the field device and a supply voltage exceeds a certain voltage level. When the controlling device detects the switching-on or a switched-on state of the field device unit, the controlling device downloads or reads out the network feature identifier or the network feature from the network feature carrier device and forwards the network feature to a switching center device of the data network or the communication network via the communication device.

According to another aspect of the present invention, a switching center device comprising a registration device, an internal data interface for connecting to a private network, and an access interface for receiving and/or accepting a connection request from a field device unit is described. The switching center device further comprises a transmission mode switching device.

The registration device is adapted to receive a network feature from a field device unit and establish a link and/or a rejationship between the network feature and internal addressing information. The transmission mode switching device is adapted to receive a switching command and switch a packet transmission mode of the switching center device on and/or off in accordance with the switching command.

In another example, the transmission mode switching device may be adapted to determine whether addressing information assigned by the registration device for a field device device and, in particular, for a network feature carrier unit of the field device unit, is announced outside of the switching center device.

The access interface may be an interface to a wired or wireless communication network. The access interface may be, for example, an air interface of a mobile communication network.

An external controlling device, for example, a measuring instrument access apparatus, may access the switching center device via the access interface and set a packet transmission mode. In one example, the switching center device may be an APN device that has the access interface. The packet mode can also be set via special commands or also via a control console.

The switching center device of the data network may be a management device of the data network that can distinguish between different network feature carrier devices, SIM cards and, therefore, field device units that have a corresponding network feature carrier device, within the internal network by means of the network feature. The controlling device is further adapted such that, upon detecting that the field device has been switched on, said controlling device downloads or reads out a field device feature from the field device feature carrier device and forwards said field device feature to the inventive measuring instrument access apparatus and/or the switching center device of the data network via the communication device.

In one example, the field device feature carrier device and the network feature carrier device may be different devices, which can be queried with different commands and/or via different protocols.

A plurality of features may therefore be assigned to one field device unit. On the one hand the field device unit or the field device may have an individually registered feature, such as a serial number, which enables the field device unit to be distinguished from other field device units, for example from other field devices of the same design. This field device feature may be assigned by a manufacturer of the field device and the assignment process may provide that a worldwide unique identifier is assigned individually to each field device. This field device identifier or the field device feature is permanently associated with the field device. The field device identifier is unknown in the internal data network, in particular on a network layer of the OSI reference model, and can also not be routed in the internal data network. In a data network that operates on layer 3, the individual field device feature and/or also the network feature of individual devices connected to the data network are substantially unknown, because the data network does not perform the task of transporting information on the basis of identifiers of higher levels. A switching center device may nevertheless know the network feature and can also output said network feature. Thus, in a GSM network in both the access network and the switching network, the IMEI may be determined and distributed in the data network in the background. An APN, for example, knows the IMEI of an active participant and can also output this when necessary. It is substantially also possible for the measuring instrument access apparatus to at least partially have the functionality of a switching center device.

The field device identifier can be physically retained or applied in the field device unit in the form of a serial number, for example. In one example, the field device feature can be applied on the housing of a field device unit. The field device feature can also be applied, however, in a firmware or in a defined memory area of the field device unit in the form of hardware or permanent wiring. In this case, the field device feature can also be downloaded or read out by means of standardized commands, such as, for example, a standardized description language or a user interface. The field device feature may therefore assign a worldwide unique name or a worldwide unique identifier to the field device, outside of the area that can be accessed by means of internal addressing information or external addressing information. The field device feature and/or the network feature can be accessed via physical interfaces and appropriate values can be downloaded or read outvia these interfaces. Interfaces for downloading or reading out can be designed on the basis of RS232, RS485, USB (Universal Serial Bus), 12C (Inter-Integrated Circuit), SPI (Serial Peripheral Interface) or parallel bus systems. Protocols of higher layers can be used via the physical interfaces. The Profibus protocol, Modbus protocol, HART protocol, or also AT commands according to the HAYES standard are examples of protocols that can be used via these physical interfaces. The query can also be used via the physical layers by means of description languages, such as DTM, EDD, and Profibus. The protocols can be used, in turn, to query field device features from the field device unit on layers above layer 3.

In order to enable a field device unit in a data network, for example, in a fixed network or in a wireless network, an identifier is assigned to the field device unit, with which this field device unit can be uniquely identified within the network. This network feature may make it possible to distinguish the field device unit within a network from other units connected to the network, such as, for example, other field device units, mobile telephones, or other data transmission devices. The network feature may make the field device distinguishable for a network management device, in particular for a switching center device. This network feature must not provide any indication of the associated field device unit, however. In other words, the network feature may not provide any direct information about the associated field device unit.

A link or relationship may be established between the general field device feature and the network-specific network feature by entering an assignment of a field device feature to a network feature in a database. This link can be established in a production process, for example, when a network feature carrier device, such as a SIM card, is connected to a field device unit or is installed in a field device unit. A network feature carrier unit can also be permanently installed in a field device unit, and said network feature carrier unit can also be replaceably connected to a field device unit, however, by means of a holder or a holding device. Instead of making an entry into a database during production, a field device feature of a field device feature carrier device can also be assigned to a network feature of a network feature carrier device via downloading. A field device feature can be queried via a description language, for example, while a network feature can be queried via a special network command.

As an alternative, it is also possible for a field device unit to forward the different features to a central unit, a central server, or another network management device when said field device unit is switched on. For example, a field device unit that is connected to a network feature carrier device can forward the field device feature and/or the network feature to a destination by means of an SMS or a switched connection, such as a CSD connection, when said field device unit is switched on. The network feature and the field device feature can be forwarded either via the same path or via an alternative path. The features can be forwarded to the same network management device or to different network management devices, such as to the measuring instrument access apparatus or to the switching center device.

By assigning a field device feature to a network feature, a field device unit can be reached via the field device feature within a data network in which the network feature is used. Via this assignment of a field device feature to a network feature, it is also possible to determine addressing information or routing information that enables data packets to be forwarded to a field device. A field device feature, for example, such as the serial number of a field device, for example, can be used to access the field device in a public or private network via this serial number.

The method for controlling the access to a measuring instrument may be stored on a machine-readable storage medium. The method may be further also implemented as a program element, which, when carried out by a processor, executes the method steps for controlling the access to a measuring instrument.

According to a further aspect of the present invention, the field device feature is a network feature of the field device unit.

The network feature is an identifier, which enables the internal data interface, the switching center device, or the measuring instrument access apparatus to uniquely identify the connected field device unit at the internal data interface and distinguish said field device unit from other field device units. The network feature can be an identifier of an access network, in particular of a mobile access network. For example, a network feature is contained on a network feature carrier device, which may be fixedly or detachably connected to the field device unit.

In one example, the network feature can also be volatile, i.e., can be freely assignable to a field device unit. A communication mechanism or a messaging mechanism can be provided in the internal data interface, at a switching center device and/or on the field device unit, which distributes a network feature assigned to a field device unit, from the internal data interface, from the switching center device, or from the field device unit, to the measuring instrument access device or the measuring instrument access apparatus, in particular to the database thereof. A network feature, such as an IMEI, may be assigned only for the “lifetime” of a field device unit, that is, for example, only during the time during which the field device unit is switched on or is registered in the network. For the management of the network feature, the field device unit may have a network feature carrier device, in particular a radio unit, such as a GPRS unit, a GSM unit, and/or an LTE unit. The radio unit and/or the network function carrier device can be fixedly installed in the field device unit. In another example, the network feature carrier device or the radio unit can be detachably coupled to the field device unit via a plug-in connection, for example, as a USB dongle. The network feature may be only quasi permanently connected to the field device unit via the detachable connection of the radio unit and/or the network feature carrier device. In other words, the network feature may be connected to the field device unit to a substantially weaker extent than a field device feature, for example.

According to a further aspect of the present invention, the management device of the measuring instrument access apparatus is further adapted to determine a link or a relationship of a network feature of the field device unit to the internal addressing information of the field device unit in order to translate the field device feature into internal addressing information of the field device unit. The network identifier or the network feature itself may not be suitable for routing a data packet and reaching a destination. The network feature of the field device unit is an identifier that enables the internal data interface to uniquely identify the connected field device unit at the internal data interface. The network feature may enable the field device unit to be distinguished from other field device units that are also connected to the internal data interface. The field device unit can be uniquely reached within the network, for example, the private network, by means of the network feature.

According to a further aspect of the present invention, the internal data interface comprises a switching center device. The switching center device is adapted to establish a link or a relationshipof the network feature of the field device unit to the internal addressing information of the field device unit. An IMEI or an ICCID of a data network can be used as the network feature. By means of this network feature, a field device unit or a field device to which this network feature is assigned can be registered in a data network. The field device unit can be distinguished from other field device units for the network by means of the registration. The switching center device does not get a direct indicator or a direct reference to a field device feature, however. The switching center device can establish a link or a relationship between the network feature and internal addressing information, however, which enables the field device, to which the network feature had been assigned, to be accessed or addressed via addressing information or via a network address.

One example of a switching center device is an Access Point Name device (APN device) or an Access Point Name (APN). In one example, the switching center device, in particular the APN, may operate on OSI layer 3 and, therefore, substantially know only network-specific parameters, network-specific properties, and/or network-specific features. The network feature is substantially assigned to layer 3 and is therefore also known to the switching center device. A field device feature, such as the serial number, may be used substantially on the application layer and, therefore, is used substantially exclusively in the application layer to identify the field device unit. The application layer or layer 7 uses the field device feature, for example, the serial number, substantially exclusively for identification and is not visible at a layer thereunder. In other words, the measuring instrument access apparatus may establish a link or a relationship of parameters that are used substantially on different layers of the OSI layer model. The field device feature may be assigned to a different layer than the network feature. As a result, the switching center device may not know the field device feature, such as the serial number of the field device unit.

According to another aspect of the present invention, the internal data interface comprises a port, wherein the internal addressing information of the field device unit is related to this port at the internal data interface.

A plurality of field device units within a network can be reached via the internal data interface by means of virtual connections. The field device units, in particular the network feature carrier devices contained thereon, may become registered with network access devices, such as, for example, in a base station, a BS, or an eNodeB. A port may be assigned thereto in this registration process, and so it is merely necessary to access or address the port within the network in order to reach the device that is located behind this port and is connected to the port.

According to another aspect of the present invention, the switching center device is adapted to provide the internal addressing information of the field device unit and/or the network feature of the field device unit either automatically or upon request.

It is therefore possible to query the switching center device from a central point, for example, such as a central server, for example, to determine addressing information assigned to the field device unit or a network feature assigned accordingly to the field device unit. Furthermore, the switching center device can proactively forward the internal addressing information and/or the network feature to a central point. It is therefore possible to establish assignments of internal addressing information to a network feature.

According to another aspect of the present invention, the instruction information is at least instruction information selected from a group of instruction information, wherein the group of instruction information comprises a query, a HTTP command, a ping command, a FTP command, a SSH command, and/or a Telnet command. Examples of an HTTP command are a POST, a GET, a HEAD, a PUT or a REQUEST.

The instruction information is forwarded by the measuring instrument access apparatus to the internal data interface, i.e., for example, to the private network, in the same manner as said instruction information was received from the public network or from the external data interface.

In other words, every bit of instruction information received by the measuring instrument access apparatus is forwarded to the internal network via the measuring instrument access apparatus. As a result, the measuring instrument access apparatus can control which instruction information or which commands should be forwarded to a field device unit. In addition, the measuring instrument access apparatus can forward every instruction received to the internal network or private network and reach the desired destination there. In this way instruction information can be routed within the private network. It is therefore possible to access or address internal devices of the private network from the outside, i.e. from the public network, even though the internal descriptor thereof is not known. The substantially only path to reach the field device unit from the public network is via the measuring instrument access apparatus. Only one individual identifier, for example, a field device feature, can be given as the destination for instruction information. Furthermore, the operator of the network, in which the field device unit is located, must be known. The measuring instrument access apparatus makes an appropriate conversion to internal routing information in order to forward the instruction information to the desired destination. All instruction information moves through the measuring instrument access apparatus, however. The measuring instrument access apparatus does not merely announce addressing information to the outside, which can then be used in order to reach the destination without involving the measuring instrument access apparatus to a greater extent. Instead, the measuring instrument access apparatus is involved in the entire routing process or information distribution process by virtue of the fact that all instruction information or data packets are distributed via the measuring instrument access apparatus. In this manner, the measuring instrument access apparatus can control the access to a field device unit.

According to another aspect of the present invention, the processing capacity or the processing power of the measuring instrument access apparatus is more powerful than the processing capacity respectively the processing power of a field device unit connected to the internal data interface.

A field device unit has substantially only slight processing capacity and/or processing power. As a result, it is difficult to evaluate received data simply using a field device unit. Providing a high processing capacity in the measuring instrument access apparatus makes it possible for the measuring instrument access apparatus to investigate and evaluate data packets, and the field device unit no longer needs to deal with such operations or activities, thereby making it possible to use less powerful hardware for the field device unit. In other words, the measuring instrument access apparatus may take over tasks from the field device unit, such as security tasks, for example.

According to another aspect of the present invention, the measuring instrument access apparatus is adapted to control a packet transmission mode of the switching center device, that is, for example, to switch said packet transmission mode on or off.

As an alternative, the measuring instrument access apparatus can also control the switching center device such that the switching center device announces a link or a relation ship of the network feature of the field device unit to the internal addressing information automatically or on request.

The measuring instrument apparatus can control the switching center device such that, for example, the packet transmission mode and/or a mode for automatically providing a link or relationship of a network feature to internal addressing information or for providing this information upon request can be switched on and off.

The packet transmission mode can switch, for example, between a packet-switching transmission mode, an SMS mode, or a circuit-switching transmission mode. In the packet-switching mode, packets are used to reach destinations, such as, for example, the field device unit, whereas, in the circuit-switching mode or CSD mode, fixed connections are established via modems. A further operating mode is the use of SMS (Short Message Service) in order to exchange data. In other words, this means that circuit-switched data services (CSD) can also exist parallel to the packet-switched data services. In the CSD mode, the switching center device is contacted via a dial-up connection, which further switches the connection to the field device unit. The field device unit comprises a modem, which terminates the dial-up connection. As a result of dialing into the modem, a dynamic address is not assigned to the modem. The addressing takes place via the mobile communication number, as addressing information, and is assigned to the field device unit. This mobile communication number can be used as a network feature and is substantially always known. The mobile communication number is substantially invariable and is present in the SIM. In the case of the packet-switched data services, however, an IP address is assigned to the port at which the field device unit is connected, or is assigned to the field device unit itself, wherein said IP address does not have a unique, permanent assignment to the SIM card.

Special commands can be used to set the packet-transmission mode. The switching center device, the exchange, the APN, or the switching center, can also provide a control console, however, with which the packet-transmission mode can be switched on, switched off, or switched to another mode. In an embedded mode, field device units can connect to the switching center device and establish the transmission mode. An interface that can receive the switch-over signals may be provided at the switching center device for switching over the packet-transmission mode. The switching center device may further comprise a switch-over device, which is adapted to switch over a packet-transmission mode.

When the packet-transmission mode is switched on or is on, it can be determined via commands whether the internal address information that is known to the switching center device is announced outside of the internal data network.

The measuring instrument access apparatus or a central server can switch the packet-transmission mode on or off. In the packet-transmission mode, a network operator is capable of accessing field device units using a packet-switched technology. If the packet-transmission mode is switched on, the field device units can be accessed from outside the switching center device or from outside the APN via packet information or addressing information.

If the packet transmission mode is released in general or permitted in general, a security risk can result, since every destination at the switching center device can be reached via the packet network. This easy accessibility can also pose a security risk, however, which is why network operators usually switch off the packet transmission mode and only permit the connection transmission mode via SMS or CSD to the end devices, in particular to the field device units. A measuring instrument access apparatus or a central server, which can switch the packet transmission mode on and off can monitor and/or control the access to the internal network and also, therefore the access to the switching center device. The measuring instrument access apparatus can therefore switch on the packet transmission mode when said measuring instrument access apparatus begins to take over the monitoring and/or the controlling of the access to the internal network, since the measuring instrument access apparatus can control the security measures for the access to the internal network. The internal data network is substantially operated without security precautions, i.e., in an “open” manner, and shifts the security monitoring to the measuring instrument access apparatus.

According to another aspect of the present invention, the management device of the measuring instrument access apparatus is adapted to extract the field device feature from the external addressing information by means of pattern detection.

Addressing information, with which a field device unit can be reached in a public network, can comprise a plurality of address components. For example, addressing information can comprise a public address component and a private address component. The public address component can be used to reach the measuring instrument access apparatus within the public network. The internal address component, in turn, can be used by the measuring instrument access apparatus to determine an internal destination. For example, a URL (Uniform Resource Locator) can comprise the field device feature as part of an internal address or a private address. This field device feature can be filtered out of the entire address on the basis of certain criteria, such as, for example, pattern recognition or filtering. In one example, a network mask can be used as the filter.

Since the measuring instrument access apparatus is the substantially central point for access to a private network, the measuring instrument access apparatus can also determined, on the basis of the internal addressing information, whether a field device unit should be accessed with the instruction information or whether another action, such as, for example, a query of an information page or a web site should be carried out. A URL can provide a notation, for example, in which periods or dots separate various address components from one another. This notation can be converted to numerical addressing information, for example, an IP (Internet protocol) address. For example, the address www. Fielddevice-Tag.Serialnumber.vega.com can be subdivided into three general address components. The designation www identifies the subsequent information as a URL and, therefore, as addressing information. The component Fielddevice-Tag.Serialnumber is an internal address component, while the component vega.com is a public address component or a so called “domain”. The public address component enables the measuring instrument access apparatus to be reached in the public network. The measuring instrument access apparatus determines the internal address component in order to filter out the field device feature. In the present example, this is the field device tag or, for example, the serial number. A field device-tag or a serial number, in particular internal addressing information derived therefrom, can be used as the field device feature in order to reach the field device unit in the internal network. A field device-tag is a specific tag or feature, which may be easier to modify than a serial number. A field device-tag may also be a label, a marking, or a designation of a field device unit, which has an alphanumeric form. A tag may differ from addressing information, however, and may not substantially reference the network. A tag can be freely assigned by a customer. Since a field device tag can be easily changed, when a field device-tag is used as a field device feature, a field device unit is adapted such that, any time the field device tag is changed, this field device feature is entered and/or updated in the database of the measuring instrument access apparatus. It may be therefore be ensured that a connection to the associated field device unit can be unambiguously re-established when a request is made with the modified field device feature. A controlling device may be adapted to detect the change made to the field device feature and substantially immediately report said change to the measuring instrument access apparatus, either via the packet-oriented data network or via the circuit-switched data network or via SMS. The controlling device may therefore implement an updating mechanism.

In another example, a tag can be assigned, as an alphanumeric identifier, to the field device unit during production and can be substantially invariably disposed in the field device unit. In another example, a field device-tag can be used as a serial number.

Subdividing or resolving external addressing information into various components permits a field device unit that is known only in an internal network to be accessed from an external network without having to abandon necessary safety precautions.

It should be noted that different aspects of the invention were described with reference to different subjects. In particular, a few aspects were described with reference to device claims, while other aspects were described with reference to method claims. However, it is clear to a person skilled in the art from the preceding description and the description that follows that, unless described otherwise, any combination of features that relate to different categories of subjects is considered to be disclosed by this text, in addition to every combination of features that belongs to one category of subjects. In particular, combinations of features of device claims and features of method claims are intended to be disclosed.

### BRIEF DESCRIPTION OF THE FIGURES

Further exemplary embodiments of the present invention are described in the following with reference to figures.

FIG. 1 shows a measuring instrument access apparatus according to one exemplary embodiment of the present invention.

FIG. 2 shows a flow chart for a method for controlling the access to a measuring instrument according to one exemplary embodiment of the present invention.

FIG. 3 shows a block diagram of a measuring instrument system, which controls the external access to a plurality of field devices, according to one exemplary embodiment of the present invention.

FIG. 4 shows a message flow chart for translating a field device feature into addressing information with a switching center request during the run time, according to one exemplary embodiment of the present invention.

FIG. 5 shows a message flow chart for translating a field device feature into addressing information by means of a database, according to one exemplary embodiment of the present invention.

### DETAILED DESCRIPTION

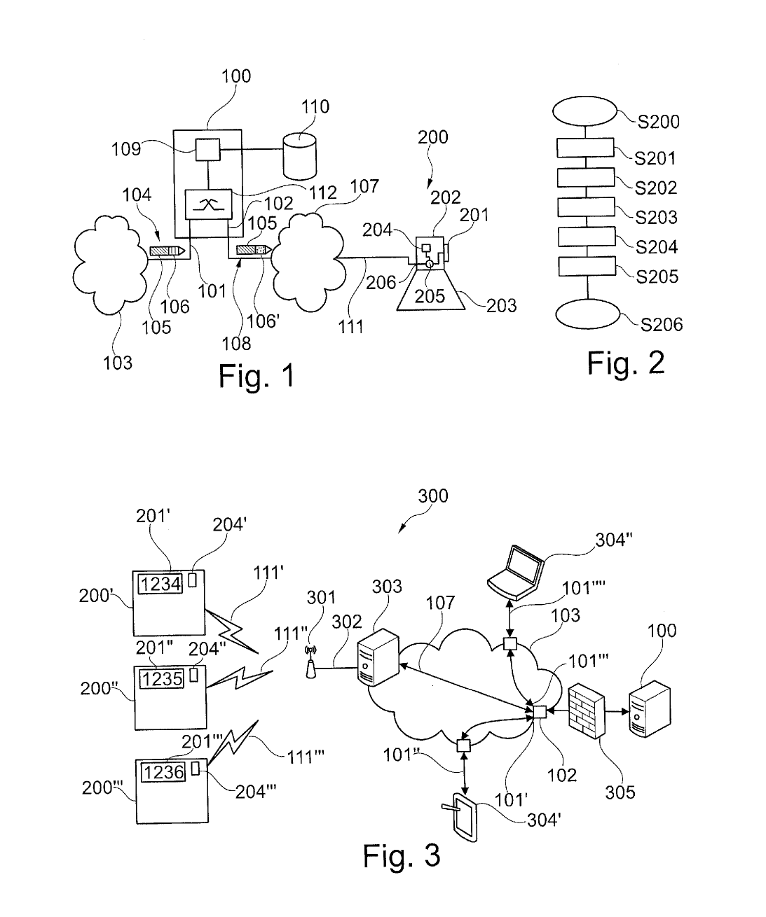

The illustrations in the figures are schematic and not to scale. In the following description of FIGS. 1 to 5, the same reference signs are used for elements that are identical or that correspond to one another.

FIG. 1 shows a measuring instrument access apparatus 100 or a central server 100 according to one exemplary embodiment of the present invention. The central server 100 comprises the external data interface 101 and the internal data interface 102. The external data interface 101 is adapted to become connected to the public network 103 or the Internet 103, that is, a public data network. To this end, the external data interface 101 receives a public address and can receive public data, public packages or public packets 104. The data packets 104 received from the public network 103 substantially have an area with instruction information 105 and an area with addressing information 106, or URL 106. The addressing information 106 or public address 106 has at least one component, by means of which the packet 104 can reach the measuring instrument access apparatus 100 via the public network 103. The measuring instrument access apparatus 100 therefore regulates the traffic that is allowed to travel from the external data interface 101 to the internal data interface 102. The internal network 107 or the private network 107 is reached via the internal data interface 102. A private data packet 108 is created in order to forward, via the private network 107, instruction information that the measuring instrument access apparatus 100 receives from the public network. Said private data packet comprises the substantially unchanged instruction information 105 from the public data packet 104. In addition, the internal data packet 108 has internal addressing information 106′, which is substantially valid only in the private network 107. The internal data interface 107 can be implemented as a dedicated line, a leased line, a network tunnel, or a VPN (Virtual Private Network). A field device unit 200 connected to the private network 107 can be connected via the private network 107. The field device unit 200 can be a sensor 200, a field device 200, or a measuring instrument 200.

In order to convert the external data packet 104 into the internal data packet 108, the external data interface 101 is adapted to receive the external data packet 104. To this end, at least one public address of the public network 103 is assigned to the external data interface. In addition, a domain name is assigned to the external data interface 101, for example vega.com. The external data interface further comprises network drivers in the form of network cards and network protocol stacks, which permit communication with the external data network 103.

Once the external data interface 101 has received a valid external data packet 104, said external data interface can extract at least the external addressing information 106 and the instruction information 105 from this data packet and forward this extracted information to the management device 109. The management device 109 can subdivide the external addressing information made available thereto such that a field device feature contained in the external addressing information, in particular in the URL, is determined, which can be used to identify the field device 200—or the field device unit 200 connected thereto—that is connected to the internal data interface 102. The addressing information can have a predefined format in order enable the field device feature to be determined from the external addressing information. The management device can further detect field device features from the external addressing information 106 with the aid of pattern recognition methods and thereby determine that the field device features are to be assigned to a field device unit 200 that is connected to the internal data interface 102 or to the internal data network 107. In other words, all requests arriving at the server 100 are analyzed in order to determine whether this is a request for a field device or whether another action is supposed to be carried out, for example, whether a home page is supposed to be displayed. As an alternative to receiving an external data packet, an input mask can be provided via a GUI (Graphical User Interface), in which a user or an application identifies itself with login parameters. For example, a web site on the home page of the device manufacturer can be provided, where registered users can log in so as to access their devices. Such an input mask can also provide the option to enter the field device feature, such as the serial number. When an entry is made in an input mask, the extraction of the field device feature can be omitted. The login parameters can be stored in the device, although it must always be possible in every case to assign the login parameters to a unique field device feature, which is stored in the field device and which, in turn, is known via the database 110 and can therefore also be assigned to an internal address.

Once the management device has filtered a field device feature out of the addressing information and recognized said field device feature, said management device can make a request in a database 110 using the field device feature in order to determine from the external addressing information 106 whether the instruction information 105 contained in the associated external data packet 104 is supposed to be or is allowed to be forwarded to the internal network 107 or to the field device 200 connected to the internal data interface 102.

The measuring instrument access apparatus 100 can therefore be a central server 100 or a central access server 100 to the internal network 107, which determines which instruction information 105 received from a public network 103 is allowed to be forwarded to a field device 200 in a private network. The central server 100 can therefore perform a security function of the private network 107 and of the field device unit 200 or the field device 200. As a result, substantially no security precautions need be implemented in the private network 107 and/or in the field device 200. Packet-oriented transmission can therefore be provided in the private network 107, for example, via which a connection can also be established from the central server 100 to the field device 200. If it were possible to only establish a CSD connection or an SMS connection between the central server 100 and the field device 200 in the private network 107, the server 100 would only be capable of accessing the field device 200 via a slow and possibly expensive data connection. The transmission of a data packet 108 over a packet-oriented network 107 can be more flexible and efficient than a corresponding CSD connection. Since the connection between the server 100 and the field device 200 takes place over a private network 107, for example, over a dedicated line 107, a leased line 107 or a VPN 107, an operator of the private network can abandon the security precautions if he so chooses; such security precautions would be activated by an operator of a public network, for example, in order to prevent access to the field device or another end device unit 200 via a network. For example, a public operator would not announce an address assigned to the end device 200 outside the network 107 in order to permit said end device to be reached via a packet network. The connection 111 between the private network and the field device 200 can be wired or wireless. One example of a wireless connection is a WLAN connection (Wireless LAN, Local Area Network). In another embodiment, a public mobile communication network 111 can also be used as a wireless connection 111. In order to use the public mobile communication network, the field device 200 logs onto a network operator as a mobile subscriber and the network operator forwards all data traffic from the field device 200 to the operator of the private network 107.

By means of the database query, the central server 100 is capable of receiving addressing information 106′, which can be used to reach the field device unit 200 in the internal network 107. The server 100 can get the internal addressing information 106′ by means of the extracted field device feature by querying the database 110, and can use said internal addressing information to forward instruction information 105 deemed to be valid to the field device unit 200. The field device feature is an identifier that is permanently associated with the field device 200. The field device unit 200 comprises the field device carrier device 201 for the purpose of providing this field device feature. This information of the field device carrier device can be accessed, for example, via query commands of a device description language, such as DTM, for example. The query can also take place via an alphanumeric and/or graphic display or a corresponding display. When a display is used, a user may be located in front of the field device and may want to access this field device. He can download, read out or read the field device feature from the field device carrier device via a display and enter the downloaded feature in a browser in the form of a URL with a special structure in order to access the field device. The field device feature may not be related to the communication network that is used. The field device feature may be a numbering scheme that is determined independently of the network addressing scheme.

The field device feature is a fixed identifier of the connected field device unit, which is substantially invariably associated with the field device unit 200 and enables the connected field device unit 200 to be distinguished from other field device units that are at least of the same design. The field device feature can be a serial number, a device number, or the like, which is permanently entered or “burned into” a firmware of the field devices 200, which is provided in a special register or special address area of a field device unit 200, that is, at a standardized location in the field device feature carrier device 201.

The internal addressing information 106′, which is determined in the database query, is addressing information via which the field device unit 200 or the field device 200 can be reached in the internal network 107. A corresponding assignment is determined by the management device 109 of the central server by means of corresponding database queries 110.

A data packet, which can be distributed or routed within the internal network 107 in order to reach the field device, is compiled as the internal data packet 108. The data packet 108 is forwarded to the switching device 112, which transfers said data packet to the internal data interface 102 in order to forward the data packet 108 to the actual location of the field device 200 by means of the internal addressing information 106′.

By means of the access server 100, it is therefore possible to convert an incoming external data packet 104 and the external addressing information 106 thereof into internally routable addressing information 106′, without the internally routable addressing information 106′ being known outside the central server 100, that is, in the public network 103. The field device feature that is stored in the field device feature carrier device 201 of the accessed field device 200 is used for the conversion. Since the internal data network is shielded by means of the access server 100, it can be permitted that, even for reaching mobile end devices 200, the packet switching technology in the internal network 107 be used to distribute the internal data packet 108. In addition to converting the external address 106 into an internal address 106′, the central server 100 can also check to determine whether certain instruction information 105 is suitable for forwarding to a field device 200 and whether, correspondingly, rights to transmit the external data packet 104 are sufficient in order to access the field device 200.

It is therefore possible, for example, to set up user groups with different authorizations for different instructions in order to individually regulate the access to at least one field device 200 or to a plurality of field devices 200 that are connected to the internal data network 107.

FIG. 1 also shows the layout of a field device 200 or a field device unit 200. The field device 200 has an electronics region 202 and a physical region 203. The physical region 203 provides the physical functionalities of the different measurement methods. The field device 200 can be, for example, a fill-level measuring device, a temperature measuring device, a flow measuring device, a limit-level measuring device, or a pressure measuring device, wherein a radar sensor, a microwave sensor, or a vibration sensor can be used for the physical components 203.

Due to access restrictions of the network operators, it is not possible to reach a wireless field device 200 from a public network 103. In order to connect to a network, the communication-capable field devices 200, for example, the wireless field devices 200, comprise a memory 204 having network features, which can be used to establish connections and identify the field device in the network. These network features are stored on a network feature carrier device 204, for example, a SIM card (Subscriber Identity Module), which is permanently or replaceably connected to the field device 200. The information stored on the network feature carrier device can be used via communication with the field device over a network that is operated by a network operator, an operator, or a provider. In order to introduce the field devices in the network, the field devices log on to a switching center device or an exchange of the network by means of the network features in order to register within the network and flag themselves as usable. The switching center device is described in more detail in FIG. 3. In the case of a UMTS or GPRS network, the switching center device can be the APN (Access Point Name) device 303 of the provider. The APN device 303 is often merely referred to as an APN 303 even though the name actually refers to an address at which the switching center device can be reached in a network. The APN is a reference to a GPRS Support Node (GGSN) and/or a SGSN (Serving GPRS Support Node). A GGSN can has various Access Points Links to a plurality of packet networks. In particular, an APN may specify a reference to an IP address in a GPRS backbone, for example an SGSN or GGSN.

Since an APN 303, in particular the APN device 303 or the switching center device 303, can enable access to a public network, such as the Internet, for example, operators of a network often attempt to establish connections, in particular packet-oriented connections, only from the end device in the direction of the public network, that is, for example, from the field device that is equipped with a network feature carrier device. Thereby, the connections into the public network lead via the APN of the provider that establishes the connection by means of the network feature carrier device or the SIM card. By permitting a connection to be established only from the field device in the direction of the public network, it is ensured that the end device, for example, the wireless field device, cannot be reached from the public network. The reason is that, when a connection is established in the direction of the public network, an internal address identifier of the field device is not communicated into the public network.

Due to this access restriction, it is not possible, for example, to reach a device, such as a field device, a mobile telephone, or a smartphone via an IP address from a public network. Addressing used in a packet network therefore cannot be used for online remote access or live remote access to such a device from the public network. In a public network only a telephone number that is assigned to the network feature carrier device or SIM card is known from the particular device, which uses a SIM, for example. However, no address that is routable in a public traffic network, such as an IP (Internet protocol) address is known or disclosed. The wireless devices, field devices, or mobile telephones can therefore be reached from the public network only by services that use the telephone number that is assigned to the field device by the network feature carrier device. Services that are available via the telephone are, for example, an SMS (Short Message Service) service or a CSD service (Circuit Switched Data). A CSD service can be, for example, a call, a fax, or a data connection that uses as MODEM (modulator and demodulator).

Therefore, if the intention is to remotely access such a field device online via the network, this is only possible via a time-oriented data connection or a time-oriented dial-up connection. In a CSD connection, modems are dialed using a dial-up connection and the charges therefore are based on time. Charges are therefore incurred even when no data are transferred. An SMS may be charged for each message that is sent. The costs incurred for an SMS or a CSD connection per a volume of data may be high compared to costs incurred for packet-switched data. In addition, dial-up connections and data transmission by means of an SMS service are not well-suited for rapid data transmission of large quantities of data.

Data network providers permit access to the devices via SMS or CSD connections, but do not permit remote access to these devices via packet-oriented data transmission technology. This prevents devices from being flexibly, uncontrolled or randomly accessed from the outside, wherein these devices may otherwise be exposed to the accesses without protection and the users are protected from hidden costs. Since, in addition to the SMS and CSD services, which charge by the minute or data volume, a charge can also incurred for the volume that is transmitted when packet transmission is used. Packet-oriented data services are often billed on the basis of the volume of data transmitted. When a SIM card is used in a field device, the fee structures of the mobile network operators apply. Such a structure can provide that a certain volume of data is included in a basic rate. Once the volume of data has been exceeded, however, either the transmission speed is reduced or a higher volume-based rate is used to charge for the volume of data that is transmitted.

The public network usually also offers access to the Internet, which uses IP-based data transmission. Since packet-oriented data transmission is often IP-based, commands such as a ping command could be used, which enables every user or the user's device to be accessed, the destination address of which is known in the Internet or in the public network. If the device were reachable via the public network, the device would possibly respond to such a ping command. Since a device that responds to a ping command could be attacked from the public network via such a connection, the network operators prevent the IP addresses from being announced, with the result that online access of the devices is not possible. Since the IP address of the end devices is not announced in the public network, a user is unable to query a field device, either via an application, a query computer, or a smartphone, either with good intentions or bad intentions. Operators of such end devices may often want to be able to access these devices from the outside, however. Access from the public network can be granted by means of an access server 100.

The field device unit 200 comprises the field device feature carrier device 201, the network feature carrier device 204, and the controlling device 205 or controller 205. The field device unit 200 further comprises the communication device 206 or interface device 206, which enables communication with the data network 107 and, in particular, with the wired interface 111 or wireless interface 111. The controlling device 205 is adapted to detect the switching-on of the field device 200. After detecting the switching-on of the field device 200, the controller 205 downloads or reads a network feature, which is stored in the network feature carrier device 204, and forwards this network feature via the communication device 206 to a switching center device of the data network 107, wherein said switching center device is not illustrated in FIG. 1.

The controlling device 205 can also be adapted such that, after detecting the switching-on of the field device, said controlling device downloads or reads a field device feature from the field device feature carrier device 201 and also forwards said field device feature to the non-illustrated switching center device via the communication device 206. As an alternative or in addition, the controlling device 205 can also forward the ascertained field device feature to the measuring instrument access apparatus 100 or the central server 100. A communication path that is routed over the internal network 107 can be used to forward the field device feature, although another connection can be used, for example, a connection in an alternative network, which is operated parallel to the internal network 107 and is provided for the communication between the field device 200 and the central server 100.

FIG. 2 shows a flow chart for a method for controlling the access to a measuring instrument 200 or field device 200. The method starts in the start state 5200 and, in step S201, receives a data packet via an external data interface. In step S202, external addressing information and instruction information are extracted from the received data packet or the external data packet 104. In step S202 as well, in parallel with or sequentially relative to the extraction of the external addressing information, a field device feature contained in the received data packet 104 is extracted, which permits identification or back tracing of the field device 200 to be accessed or to be addressed and which is connected to the internal data interface 102 of a central server 100.

In step S203, a check is carried out by means of a query of a database 110 as to whether the ascertained instruction information is supposed to be or is allowed to be forwarded to the field device unit 200. In step S204, the ascertained field device feature is translated into internal addressing information 106′, which can be distributed via an internal data network 107. In step S205, the extracted instruction information, about which it was determined that this should be or is allowed to be forwarded to the field device unit 200, is indeed forwarded to the field device unit 200, which is connected to the internal data interface 102 of a server 100, via the internal data interface by means of internal addressing information of the field device unit.

The method then ends in the end state 5206.

The internal addressing information of the field device unit 200 is an identifier for the location at which the field device unit is located at the internal data interface 102, for example, a port at the internal network 107 that establishes a connection to the interface 111. The internal addressing information can be an identifier for the field device 200 that is temporarily assigned. For example, the internal addressing information 200 is valid and available only for the time during which the field device unit 200 is connected to the data network 107 via the access line 111 or the access connection 111. If the access connection 111 is cut off and re-established, internal addressing information can be assigned that differs from addressing information that was previously assigned. That is, the internal addressing information used to reach the field device unit 200 in the internal network 107 is variable and is managed by the database 110.

FIG. 3 shows a block diagram of a measuring instrument system 300, which controls the external access to a plurality of field devices. Three field devices 200′, 200″ and 200′″ are shown in FIG. 3. Each of the field devices is connected to the internal network 107 via a wireless access or mobile access of a public mobile communication network 111′, 111″, 111′″. A secured connection 107, which is routed over the public network 103 or the Internet 103, is depicted as the private network 107 in FIG. 3. As an alternative to such a private network 107 or VPN 107, which is superimposed on the Internet, the internal network 107—as illustrated in FIG. 1—can also be embodied as a separate network, for example, via a dedicated line 107, and therefore the internal network 107 and the public network 103 are physically separated networks. The access connections 111′, 111″, 111′″ connect the field devices 200′, 200″, 200′″ and, in particular, the network feature carrier devices 204′, 204″, 204′″ thereof, for example SIM cards 204′, 204″, 204′″, which are provided on the field devices, to a switching center device 303 of the mobile network operator, in particular to the APN 303 of the mobile network operator, said switching center device being connected via the link 302. The access connections 111′, 111″, 111′″ extend over a base station 301 of a mobile network operator. Without loss of generality, a switching center device 303 is understood to be an APN 303 of a mobile radio network.

The switching center device 303 is the field-device side access point to the private network 107. The private network is connected to the central server 100 via the data interface 102. In FIG. 3, the internal data interface 102 also simultaneously provides external data interface 101′, 101″ for external applications 304′ and 304″ and the users thereof. The external applications 304′, 304″ can be, for example, notebooks, PCs, or smartphones, which shall be used to access the field devices 200′, 200″, 200′″ via the external connections 101′, 101″, 101′″, 101″″. The firewall or security device 305 is provided at the external interface 101′, 101′″ in order to secure the external connections 101′, 101″, 101′″, 101′. The firewall 305 can implement complex security mechanisms, since said firewall is not restricted by limited computing capacity or computing power, as is the case with a field device, for example.

Operators of mobile communication networks offer customers the service of operating their own APNs, for example, in order to establish M2M networks (machine-to-machine networks). Since these APNs 303 or switching center devices 303 are operated as proprietary APNs of a company, thereby ensuring that these APNs cannot be accessed from the outside, the operators are also willing to operate these APNs in a packet-transmission mode. When operating in a packet-transmission mode, it is possible to access addresses of the field devices 200′, 200″, 200′″ via a network, for example, the internal network 107, wherein the addresses are announced or discclosed by the APN 303, without the need to connect SMS or CSD-connections in combination with telephone numbers of the field devices. By means of the release or permission of the packet-transmission mode, the field devices 200′, 200″, 200′″ can be randomly, uncontrolled or as needed accessed and, therefore, any information can be exchanged with the field devices. The packet-transmission mode of the APN 303 can be switched on or off by the central server 100 via special commands or via a GPRS user interface. By the switching on or off, or by the switch-over of the packet-transmission mode, it can be determined whether the field devices 200′, 200″, 200′″ should be reachable via announced or disclosed addresses, for example IP addresses, in the internal network 107, or merely by means of an CSD/SMS connection. If the packet-transmission mode is switched on, the IP addresses can be reached; if the packet-transmission mode is switched off, the IP addresses cannot be reached, and the field devices can only be accessed via a CSD- or SMS-connection. The APNs 300 released or enabled by the network operators or the proprietary APNs 300 are connected to the private network 107 or the dedicated line 107 to the private network of a company. It is thereby possible to establish a connection to the field devices 200′, 200″, 200′″ from the private network 107. These addresses cannot be reached from a public network 103, for example, from the Internet. A proprietary APN may also be referred to as a company owned APN.

The central server 100 can assume the role of a network access controller and disconnect or separate the private network 107 from the public network. It is therefore possible to implement monitored tele access or remote access to the field devices via the Internet 103. Since this access via the Internet always takes place via the central server 100, the security level with which the company that operates the server permits access to the field devices or end devices 200′, 200″, 200′″ from the outside can also be set at this time. Therefore, the complexity of the software or the computation required to provide the security functions need not be provided on the field devices and is transferred to the central server, thereby ensuring that the complexity of the hardware of the field devices 200′, 200″, 200′″ can be minimized.

The central server 100 can be reached via the public network 103 or the Internet 103. This server can be a powerful computer and can therefore implement complex firewall technology and security mechanisms. The security standard can also be updated to reflect the applicable and most recent findings at a particular time. Applications 304′, 304″ that want to access the field devices from the public network, that is, from outside, from a standard PC, tablet computer, smartphone or any other device 304′, 304″ that can access the Internet direct their requests to the central server or network access server 100. The server 100 receives the requests in the form of public data packets 104. The server evaluates the request 104 and possibly requests that the applications 304′, 304″ or the users thereof authenticate themselves. After successful authentication, the server 100 forwards the request 104, in particular instruction information 105 contained in the request 104, to the APN 303 of a mobile network operator via the internal network 107 or, in a simple case, via the dedicated line 107. This connection between the central server 100 and the APN 303 can also be equipped with sufficient security mechanisms. IP Sec, TLS, or SSL can be used, for example, as the security mechanism in the private network 107, in particular in the connection between the central server 100 and the APN 303. Since the security mechanisms are implemented by the central server, the hardware and software complexity for security mechanisms in the field device 200′, 200″, 200′″ itself can be omitted.

The APN 303 of the provider is connected to the field devices 200′, 200″, 200′″. The connection between the APN 303 and the field devices 200′, 200″, 200′″ is a packet-oriented data connection and can be bidirectional. That is, the APN 303 announces or discloses the IP addresses or network address information 106′, at which each of the field devices 200′, 200″, 200′″ can be reached, in the private network 107.

The IP addresses themselves, to which the field devices are assigned, are reported by the APN to the central server 100, but are not visible in the public network 103, for example, the Internet. If the intention is to access the field devices, the connection must take place over the central server that hides the IP addresses of the field devices from the public network. In order to establish the connection, public addresses are translated into the internal addressing information 106′ in the server, where authentication also takes place.

By means of the transmission mode switchover device, which is not shown in FIG. 3, the central server 100 can not only switchover the packet-transmission mode, but also determine whether the internal addressing information is allowed to be distributed, that is, whether the APN 303 is allowed to forward the internal IP addresses to the server 100.

A request 104, which has instruction information 105 and a public address 106, for example, a URL 106, originates from the applications 304′, 304″ that want to access a field device from the Internet 103. The URL is structured such that said URL addresses the server in the public network and also contains an identifier in order to clarify which of the plurality of field devices is intended to be accessed. In one exemplary embodiment, a public data packet 104 can also contain authentication information, which can be automatically checked without providing a special authentication screen. If the data packet 104 does not contain authentication information, the authentication must take place separately after the data packet 104 is received, for example, via a separate authentication mask or a separate authentication screen. A certificate-based access mechanism or systems having various “token” principles can be used for the authentication. In the case of authentication on a screen or a user interface or a GUI, an SSL (Secure Sockets Layer) encryption or TLS (Transport Layer Security) encryption can be used in various stages, for example, with 128-bit or 256-bit encryption.

The APN 303 provides the server 100 with all addresses 106′ of the field devices 200′, 200″, 200′″ that are reachable through said APN, and therefore the server 100 knows which field devices can be reached via said APN and/or via said server.

The public addressing information 106 or the URL 106 can have a special structure that enables the server to extract a field device feature from the URL, with which the field device 200′, 200″, 200′″ can be addressed. The URL can have the form www.Fielddevicefeature.PublicAddressingInformation.

The public addressing information can be a network address or a domain, for example the company that operates the access server 100 and would like to provide access to the field devices 200′, 200″, 200′″. For example, the network address or the public component of the URL can include the designation vega.com in order to reach a server 100, which is operated by the company VEGA. The entire address can then have the format www.Fielddevicefeature.vega.com. The serial number of the associated field device 200′, 200″, 200′″ or the IMEI of the field device can be used as the field device feature. In this case, the public address information 106 or the URL 106 then appears, for example, as www.Serialnumber.vega.com or www.IMEIofFielddevice.vega.com. From this URL, the central server can extract the field device feature of a field device, which is stored on the field device feature carrier device 201, using pattern detection methods, for example. Such a field device feature can be, in particular, the serial number or the IMEI of the field device which is intended to be accessed from the outside. In one example, the server 100 knows that the field device feature is always contained between the first and second point or dot of the URL 106.

The extracted field device feature 201 can be compared with the data delivered by the APN 303 and the internal addressing information 106′, for example the internal IP address or the private IP address of the field devices 200′, 200″, 200′″, can be found. The comparison can be carried out, for example, via a database query 110. After the server 100 has ascertained or determined the internal addressing information 106′, said server can forward the request 104, in particular the instruction information 105 contained in the request 104 or in the request packet 104, as an internal data packet 108 to the respective field device 200′, 200″, 200′″ via the APN 303. The server 100 can ensure a high security standard and also permit the dreaded access to the APN 303 without the need to change the hardware complexity or software complexity of the field device 200′, 200″, 200″.

A link or relationship between the field device feature, which may be stored in the field device feature carrier device 201, and a network feature, by way of which the field device 200′, 200″, 200′″ is known to the APN, can be created in the database 110, for example, during production of the field device 200′, 200″, 200′″. In other words, this means that a field device has a field device feature, which has been substantially individually assigned to the field device, by means of which the field device can be distinguished from other field devices. The field device feature is stored in the field device feature carrier 201.

A network feature is assigned to the field device and is stored in the network feature carrier device 204 during production as well. The network feature is assigned to the field device in the case of a mobile network, for example, by installing a SIM card, whereas the field device feature is burned into or permanently stored in the firmware or in an address area of the field device. The network feature carrier device 204 can be provided as a SIM slide-in component, whereby the SIM card can be replaced at any time, thereby making it possible to establish a new assignment between a network feature and a field device feature. This can be the case, for example, when introducing a new network access standard for the network access 111, by means of which the transmission technology 111 and the identification technology may change, but the field device feature is not changed. It may become necessary to replace a SIM card in this manner, for example, when switching to a new transmission technology, for example, from GSM to UMTS or from UMTS to GSM. The link or the relationship between the network feature and the field device feature can also be created during the run-time of the device, however.

In order to ensure that a combination of the network feature, the field device feature, and/or the addressing information remains correctly assigned when the links or relationships are changed, various mechanisms can be applied when a change is detected in the system, in order to update the assignment. On the one hand after a change is detected, a one-time, manually initiated update communication to the central server can take place. On the other hand, it is also possible, however, for the assignment to be automatically renewed or updated by transmitting the data, for example, the network feature and the field device feature, in particular the serial number, from the field device to the central server. The assignment can also be manually entered at the central server via a user interface. In addition, the assignment can be automatically updated at the central server by means of a regular, cyclic comparison, which is initiated by the field device, for example.

The serial number or the production number of the field device can be used as identifiers for the physical field device or as field device features. It is possible to use GSM parameters, such as IMEI, ICCID, IMSI (International Mobile Subscriber Identity), as the network feature. The link or relationship of the field device feature, the network device feature, and/or the addressing information, for example, the URL, can be established during the run-time of the device, that is, while the device is switched on, or at the time when the addressing information is required, or at the time of production.

The user can therefore enter a request to a URL, for example, via a standard Internet browser, which contains a specific field device feature of the field device to be accessed. This field device feature is packed into a URL. This URL or external addressing information is translated in the background by the central server 100 into the internal addressing information 106′ of the field device and is forwarded to the internal network.

The field device can then receive the request 108, in particular the instruction information 105 contained in the request 108, in a web server, which is integrated on the field device 200′, 200″, 200′″ and runs on the controlling device 205, for example, and said field device can return a response to the corresponding requesting address. This response from the field device is returned to the central server 100 with an internal address. The central server, in turn, has the information as to from which external address the request originated and ensures that the data are forwarded correctly. The application 304′, 304″, that accesses the field device must not know the background IT structure and, in particular, the interaction of the APN and the central server. It only needs to know external addressing information 106 or the URL 106, which is provided thereto by the company that operates the internal network 107, for example, in order to access or address the associated field device. The requesting address can be assigned to the field device via the feature contained in the URL, in particular the field device feature that belongs to the field device to be accessed or addresses. This field device feature can contain the serial number or another identification, too. The field device feature can be composed, for example, of a customer name and a device number, or can comprise a field device tag and a serial number. It is also possible to use the IMEI of the modem provided in the network feature carrier device 104, an ICCID of the SIM card 204 that is used, or a name that an application uses for the field device. The external addressing information 106 can appear as follows, for example:
www.Customername.Devicenumber.vega.com
www.Fielddevice-Tag.Serialnumber.vega.com
www.IMEIofModem.vega.com
www.ICCIDofSIMca.rd.vega.com
www.myName.vega.com

A network feature can also be used as the field device feature, which means that conversion of the field device feature into a network feature can be eliminated. The IMEI can be invariably introduced in the field device, for example, when a network feature carrier device is installed in a substantially non-detachable but rather permanent manner. In this case, the field device feature can be the same as the network feature and, for example, the IMEI will then be used as a field device feature. Furthermore, a SIM card can also be permanently installed and therefore bring about a permanent assignment between the ICCID and the field device feature. The ICCID can then also be used as a field device feature, since the feature and the device are connected in a substantially inseparable manner.

In the case in which only a network feature and not a field device feature is used in the address 106, an error may occur if the database 110 is not specifically harmonized. A SIM card can be easily transferred, for example, from one field device to another, whereby the assignment of the network feature to the addressing information would no longer be current and would no longer access the desired field device. The use of a field device feature to access the field device can increase reliability, since it is highly unlikely that a field device feature that is permanently associated with the field device will be changed.

The assignment of external addressing information 106 to the field device 200′, 200″, 200′″, in particular to the field device feature and/or to the network feature, can also be updated via the application 304′, 304″, by a user of said application, through an input mask provided by the server 100. Thus, it is possible, for example, to assign a new network feature for a field device, for example, by replacing a SIM card, simply by the user notifying the server that the network feature for a particular field device has changed. The same applies for the field device feature.

The field device feature, for example, the serial number, can always be entered on the same Internet page, for example. In other words, this may mean that the field device is not selected by extracting, from the URL, information that is assigned to the field device to be accessed, but rather data of the corresponding field device are accessed by entering a field device feature or a network feature via an input mask on a web site. The step of extracting the field device feature can be omitted in this case. In particular, the extraction step is then subdivided into two sub-steps, which provide for logging on to an input mask including authentication and/or authorization, and ascertaining the field device feature by evaluating the entries in the corresponding input mask. The server that provides the input mask then forwards the requests to the appropriate device. Authentication can take place using a password or token system.

One concept of the invention may be that of establishing a bidirectional connection via a packet-oriented data connection or via a packet-oriented data network to the field device, which uses an insecure, open, internal network 107, but which is protected by an access server 100.

If the security standard is negligible, the IP address assigned by the APN 303 for a field device could also be announced or disclosed. A secured connection 107 between the APN 303 and the central server 100 is substantially the only way, however, to ensure that accessing the end devices 200, 200′, 200″, 200′″ with the internal private addresses 106′ by the central server 100 and the access protection installed there does not result in increased data traffic. Although the IP addresses are basically public, these cannot be accessed from the one distant station or peering station in the public network. A normal public APN 303 blocks such requests. The access control by using the central server 100, makes it possible, however, for the APN 303 to announce or disclose the addresses of the end devices 200, 200′, 200″, 200′″. The central server 100 can switch the announcement, the disclosure or the publication of the IP addresses on or off via the transmission mode switch-over device of an APN 303. The central server is therefore capable of not only switching between a packet-transmission mode and a circuit-switched transmission mode, but also to initiate the announcement or the disclosure of the internal address information. The modes can be switched over independently of one another. Announcing or disclosing all of the internal address information in the public network could increase the security risk, and the SIM card owner could incur hidden charges.

In an alternative embodiment, the APN 303 could have the functions of the central server 100 and handle the assignment of the internal addresses to field device features or network features that are extracted from external addresses. In another example, the central server could also perform the function of an APN. In such a case, the internal data network 107 would be an internal connection within the server 100.

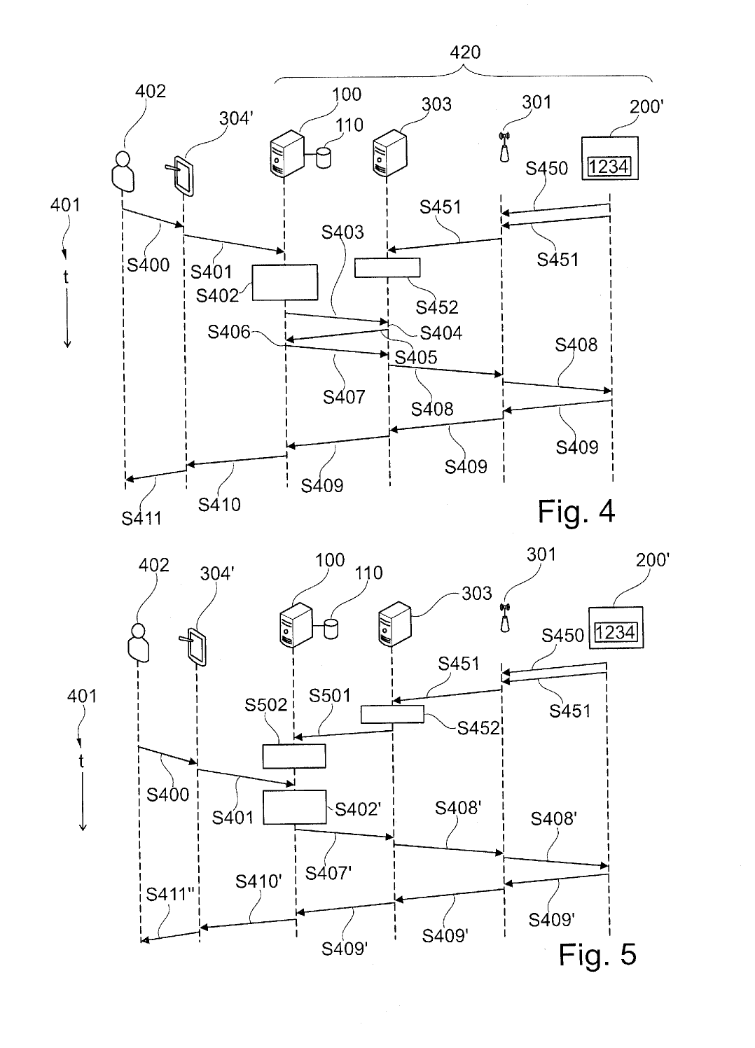

FIG. 4 shows a message flow chart for the measuring instrument system from FIG. 3, in which the relationship between addressing information and field device feature is ascertained or determined during the run-time or as needed, according to one exemplary embodiment of the present invention. This message flow chart shows the course of an exchange of a message packet between the various components of the measuring system 300 along the time axis 401. In the message flow chart, the first column shows a user 402, who operates a tablet PC 304′, for example, as the application.

When the field device 200′ is switched on, the field device 200′ registers itself with a base station 301 of a mobile network operator assigned thereto, in step S450. The field device 200′, which has detected the switching-on, then establishes a connection to a switching center 303 assigned to the field device, via the base station 301. In so doing, the field device may log on to or register itself with a registration device in the switching center device 303, which is not illustrated in FIG. 3. In the registration, the field device 200′ discloses its network feature or plurality of network features to the switching center device 303 or the APN 303, also in step S451. The APN 303 can identify the SIM card and, therefore, indirectly, also the field device 200′ via the network feature from the network feature carrier device 204′, for example, an IMEI from a SIM card. With this information, in particular the network feature, the APN 303 can determine, in step S452, whether the device 200′ is known by the APN 303 and is allowed to establish a connection to the APN. If this is the case, the APN 303 can determine whether the device 200′ is actually connected to the APN, that is, whether the field device 200′ is switched on. In step S452 as well, the APN 303 assigns an IP address to the field device 200′. In particular, this internal addressing information or private addressing information is assigned to an access port or an end of a network connection in the private network 107.

In other words, after the registration of the field device 200′, an information database in the APN 303 has an assignment of a private address, for example, a private IP address, to one or a plurality of network features, which were downloaded from the network feature carrier device 201 from the field device 200′ having the serial number 1234. After the field device 200′ is switched on and registered, the APN 303 detects an assignment of the internal addressing information or private addressing information for the field device 200′ to a network feature, which is associated with the field device 200′. For example, the APN 303 detects an assignment of a private IP address to an IMEI of the field device 200′. Or, in other words, the APN 303 detects an assignment between information of layer 3 of the OSI model. The APN 303 may not be capable, however, of detecting an assignment of a field device feature to an IP address. The field device feature is managed by protocol layers located above layer 3 and, therefore, the APN 303 cannot perceive the field device feature. In one exemplary embodiment, however, a switching center device, such as an APN 303, may be adapted such that information of higher protocol layers can be accessed and the APN can perform the management of the assignment of.

IP addresses and field device features. After the functions of the APN 303 have been thusly expanded, said APN knows company-specific field device features, although these are not standardized or generally common.

In step S400, independently of the registration in steps S450, S451, S452, the user 402 enters the public addressing information or URL 106 in the tablet PC 304′ or in the application 304′. For example, the user enters the URL www.1234.vega.com in order to query the field device 200′ having the serial number 1234, which is stored in the field device feature carrier device 201′ of the field device 200′. The different serial numbers are stored in the field device feature carrier devices 201′, 201″, 201′″ for the purpose of distinguishing the field devices 200′, 200″, 200″. The first field device 200′ has the serial number 1234, the second field device 200″ has the serial number 1235, and the third field device 200′″ has the serial number 1236. The input device 304′, for example, the tablet PC and, in particular, an application on the tablet PC 304′, generates a data packet 104 from the entry of the URL 106 www.1234.vega.com, wherein said data packet has the request in the form of instruction information 105 and has the addressing information 106 in the form www.1234.vega.com. This request is generated in step S401 and is forwarded to the central server 100 via the public network 103. The forwarding can be carried out using the DNS (Domain Name Service) service, for example. The server 100 can be reached in the public network 103, for example, via the network component or the domain name vega.com. The private component www. 1234 of the public address 106 can be formulated as sub-addressing, which can be assigned by the operator of the central server 100. In step S401, the input is transferred to the server 100 via the public network.

In step S402, the server 100 ascertains the structure of the data packet 104 sent thereto and extracts the internal network component www. 1234 as private addressing information. The central server extracts the serial number 1234 of the desired field device 200′, as the field device feature, from this private addressing information. In step S402, the server then determines whether the serial number 1234 is assigned to a field device 200′ that is managed by the server 100 and, in particular, the company that operates the server 100. In another example, as an alternative or in addition, the server 100 can also determine whether the user 402 is authorized to access the field device unit 200′ having the serial number 1234.

Once the central server has determined, in step S402, that the serial number 1234 is assigned to a device, the central server determines associated internal addressing information from the field device feature that was extracted from the addressing information. In order to perform this translation, the requested field device feature was assigned to an associated network feature in the database 110 of the central server 100, for example, in a production process or in a procedure in which the network operator of the private network 107 assumed responsibility for the field device 200′. It is thereby determined whether a device is assigned to the field device feature. The network feature could be the IMEI or the ICCID, for example.

In step S403, the central server requests the assigned APN, with the aid of the network feature ascertained from the database 110, to provide said central server with internal addressing information 106′ associated with the ascertained field device feature and the network feature derived therefrom. For example, the server 100 requests the APN to provide an IP address of the ascertained IMEI or ICCID.

In step S404, the APN 303 determines whether there is a registered field device 200′ for the requested network feature and, if so, determines the addressing information thereof, which was previously ascertained by the APN 303 in step S452. Addressing information can be, for example, an IP address that is assigned to the field device 200′. After an associated IP address for the requested field device feature has been ascertained, the APN 303 makes this IP address available to the central server 100, in step S405. With the aid of the internal IP address 106′, which is now known, the central server 100 can compile an internal data packet 108 in step S406, in which said internal data packet the ascertained or determined internal IP address 106′ is linked, assembled or combined with the instruction information 105 that is received.

In step S407, the internal data packet 108 is initially forwarded, as a request, to the APN 303. The APN 303 functions as a router between the mobile communication network 111, 111′, 111″, 111′″ and the central server 100. It 303 switches or routes the IP addresses provided by itself 303. Once the APN 303 has received the internal data packet 108 and has evaluated the internal addressing information 106′, the APN forwards the internal data packet 108 to the associated field device 200′ via the base station 301 in step S408. On the basis of the IP addresses that were assigned, the APN 303 can analyze which of the mobile subscribers 200, 200′, 200″, 200′″ is supposed to receive the data packet 108.

The field device 200′ receives the request for the data packet and can forward the response to the central server 100 via the base station 301, the APN 303, in step S409. For the response, the field device uses the internal IP address or at least the URL of the central server 100, which it must know. In other words, for the response, the field device uses the internal IP address or at least the URL of the central server 100, which address or URL the field device must know. This can be transmitted in the request S406 with the data packet, for example. The server, in turn, ascertains the public IP address of the requesting device 304′ associated with the response and, in step S410, responds to the request by the application 304′ with a public address. In step S411, therefore, a user can read the requested data, for example, a measurement value provided by the field device 200′.

For his request, the user 402 does not need to have knowledge of the internal structure 420 of the service provider or the operator of the internal network 107. It is only necessary to know the network addresses of the central server 100 in the public network and to know the corresponding field device parameter, such as, for example, a serial number and/or a network feature of the field device 200′. Furthermore, the user must know how public addressing information 106 or a URL is formed out of the field device feature or the network feature in order to query the associated field device.

FIG. 5 shows a message flow chart for querying a field device 200′ with a database 110, which has stored internal addressing information and is maintained by the server 100, according to an exemplary embodiment of the present invention. As previously illustrated in FIG. 4, the field device 200′ establishes a connection, in steps S450 and S451, to the switching center device 303 via the base station 301 when switched on and discloses the IP address assigned to a network feature to said switching center device. As previously described with reference to FIG. 4 as well, the APN determines, in step S452, whether the field device 200′ is known in the network and whether it is connected. As soon as it has been determined that the field device 200′ is known and connected, the APN 303 transfers, in step S501, the IP address or internal addressing information that said APN has assigned to the field device 200′. Before an evaluation and assignment of the features to addressing information can take place in the server, the APN 303 must also transfer an associated network feature, for example, an IMEI or an ICCID, in step S501. This transmission can be transmitted in the same packet or in different packets. The transmission can also take place on different transmission routes, for example, the addressing information can be transmitted via a packet-switched network and the network feature can be transmitted via a circuit-switched network, for example, as CSD or SMS. In step S502, the server 100 receives the internal addressing information of the field device 200′ and enters this in the database 110 of the central server. The server 100 can make an assignment to a field device feature that was previously entered in the database 110, for example, a serial number, via the network feature, for example, an IMEI, which the APN also transmits to the server together with the addressing information, for example, an IP address. The assignment of the network feature and the field device feature is then carried out via the database 110. The features are linked in the database 110 via the transmitted network feature, which must also be stored in the database, and the field device feature. A user can thereby access the field device without having knowledge of the network feature or the internal addressing information. The user only needs to know the field device feature. The link or relationship of a field device feature to the associated internal addressing information or IP address of the field device 200′ via the network feature is therefore known substantially immediately after the field device 200′ is switched on. It is therefore possible to avoid a query and determination of the assignment of the addressing information by querying the APNs on the run-time, as described in steps S403, S404, S405. If the user 402 sends his request to the server, in step S400, via the query device 304′ or application 304′, the server can immediately determine, in step S402′, whether the field device feature, for example the serial number 1234, is assigned to a device 200′.

As an alternative, once a network feature and internal addressing information have been assigned to the field device 200, 200′, 200″, 200′″, said field device 200, 200′, 200″, 200′″can also access the server 100 by sending the server 100 a data packet via a packet connection, via an SMS connection and/or via a CSD connection, and transmitting to the server 100 substantially at least information selected from a field device feature, a network feature, and internal addressing information. The server stores this information in the database 110. In other words, the central server 100 is responsible for creating a link or a relationship between the field device feature and the internal address. The linking element in this case is the network feature, which the central server 100 has available, for example, after receiving a message from the field device 200. The transmission of the network feature can be sent to the server 100 via any route, for example, via CSD, SMS, http, etc. The network feature is known to the field device or can be ascertained thereby. The internal addressing information is disclosed, in the mobile communication area, to the field device 200, 200′, 200″, 200′″ when a connection is established, in particular when logging onto the network via the access connection 111, 111′, 111″, 111″″. The APN is therefore not absolutely necessary for the distribution of the information. When a method according to FIG. 5 is used, it is not necessary for the internal addressing information to be forwarded from the APN 303 to the central server 100. In one example, the field device can perform the task of distributing the required information without using the APN 303.

In addition, in the step S402′, the internal addressing information can be queried from the database 110, by means of which information the field device 200′ having the serial number 1234 can be reached in the internal network. In step S407′, a request with associated instruction information 105 is then forwarded via the APN 303, and is forwarded to the field device 200′ via the base station 301 in step S408′. The field device 200′ responds to the request to the server in step S409′, and said server again forwards the response to the requesting query device 304′ in step S410′, whereupon the user 402 has the data available in step S411′.

In order to ensure that the field device 200′ can be reached over the internal network 107 by means of internal addressing information 106′, the APN 303 is switched into a packet-transmission mode. That is, the APN 303 reacts to a request with addressing information in steps S407 respectively S407′, for example, with an IP address, and routes the internal data packet 108 to the field device. The server 100 can switch the APN into the packet-transmission mode or shut off the packet-transmission mode via a console connection, via which console connection commands can be exchanged between the central server 100 and the APN 303. If the server 100 switches off the packet-transmission mode of the APN 303, the APN 303 does not route any data packets, but merely SMS or CSD information.

The network feature or a network identifier is not suitable for routing and is converted into addressing information that is suitable for routing in the internal data network 107.

The network feature makes it possible to identify a field device in the network and to distinguish the field device from other field devices 200′, 200″, 200′″ connected to the internal data interface 107. The network feature is disclosed or notified by the APN 303 to the server, for example, during registration in the network. The network feature is initially only known on the APN, however. If the switching center device 303 is not adapted to forward the network feature to the central server 100, the server 100 does not know the network feature. This functionality of forwarding the network feature in the switching center can be switched on and off by the server 100 via a transmission mode switch-over device in the switching center device 303. The switching center device 303 can have an associated interface for access the transmission mode switch-over device.

The field device can transmit an ascertained or determined field device feature to the central server 100 either via the packet network 107, which is connected to the APN, or also via an alternative route, for example via SMS or CSD, instead of via the packet network.

It is also pointed out that “comprising” and “having” do not exclude other elements or steps, and “a” or “an” does not rule out a plurality. It is further pointed out that features or steps that were described with reference to one of the aforementioned exemplary embodiments can also be used in combination with other features or steps of other exemplary embodiments mentioned above. Reference signs in the claims should not be considered to be a limitation.

1. A measuring instrument access apparatus, comprising:
an external data interface configured for connecting with a public network;
an internal data interface configured for connecting with a private network;
a database;
a management device; and
a switching device
wherein the external data interface is adapted to receive a data packet and extract external addressing information and instruction information from the received data packet, and is adapted to forward the extracted information to the management device;
wherein the management device is adapted to extract a field device feature of a field device unit connected to the internal data interface from the external addressing information;
wherein the management device is further adapted to check, by querying the database, whether the instruction information is supposed to be forwarded to the field device unit that is connected to the internal data interface; and
wherein the management device is further adapted to translate the field device feature into internal addressing information of the field device unit;
wherein the field device feature is a permanent identifier of the connected field device unit, which identifier is associated with the field device unit and enables the connected field device unit to be distinguished from other field device units;
wherein the internal addressing information of the field device unit is an identifier for the location at which the field device unit is located at the internal data interface, and wherein the identifier is temporarily assigned; and
wherein the switching device is adapted to forward the instruction information that is supposed to be forwarded to the field device unit connected to the internal data interface, to the field device unit via the internal data interface by the internal addressing information of the field device unit.

2. The measuring instrument access apparatus according to claim 1, wherein the field device feature is a network feature of the field device unit and wherein the network feature of the field device unit is an identifier that enables the internal data interface to unambiguously identify the connected field device unit at the internal data interface.

3. The measuring instrument access apparatus according to claim 1, wherein the management device is further adapted to ascertain a link of a network feature of the field device unit with the internal addressing information of the field device unit in order to translate the field device feature into internal addressing information of the field device unit; and wherein the network feature of the field device unit is an identifier that enables the internal data interface to unambiguously identify the connected field device unit at the internal data interface.

4. The measuring instrument access apparatus according to claim 3, wherein the internal data interface includes a switching center device; and wherein the switching center device is adapted to establish a link of the network feature of the field device unit to the internal addressing information of the field device unit.

5. The measuring instrument access apparatus according to claim 1, wherein the internal data interface has a port; and wherein the internal addressing information of the field device unit is related to this port at the internal data interface.

6. The measuring instrument access apparatus according to claim 4, wherein the switching center device is adapted to provide, automatically or upon request, the internal addressing information of the field device unit and/or the network feature of the field device unit.

7. The measuring instrument access apparatus according to claim 1, wherein the instruction information is at least one instruction information selected from the group of instruction information including:
a request;
an http command, for example a POST, a GET, or a REQUEST;
a ping;
an ftp, ssh and/or a telnet command.

8. The measuring instrument access apparatus according to claim 1, wherein the processing power of the measuring instrument access apparatus is more powerful than the processing power of a field device unit connected to the internal data interface.

9. The measuring instrument access apparatus according to claim 4, wherein the measuring instrument access apparatus is adapted to switch a packet transmission mode of the switching center device on and/or off.

10. The measuring instrument access apparatus according to claim 1, wherein the field device feature is extracted from the external addressing information by pattern recognition.

11. A method for controlling an access to a measuring instrument, comprising:
receiving a data packet via an external data interface;
extracting external addressing information and instruction information from the received data packet;
extracting a field device feature of a field device unit connected to an internal data interface from the external addressing information;
checking, by querying a database, whether the instruction information is supposed to be forwarded to the field device unit that is connected to the internal data interface;
translating the field device feature into internal addressing information of the field device unit; and
forwarding the instruction information, which is supposed to be forwarded to the field device unit that is connected to the internal data interface, via the internal data interface by the internal addressing information of the field device unit;
wherein the field device feature is a permanent identifier of the connected field device unit, which is associated with the field device unit and enables the connected field device unit to be distinguished from other field device units;
wherein the internal addressing information of the field device unit is an identifier for the location at which the field device unit is located at the internal data interface, and wherein the identifier is temporarily assigned.

12. A field device, comprising:
a field device feature carrier device;
a network feature carrier device;
a controlling device; and
a communication device communicating with a data network;
wherein the controlling device is adapted such that, upon detecting that the field device has been switched on, said controlling device reads a network feature from the network feature carrier device and forwards said network feature to a switching center device of the data network via the communication device; and
wherein the controlling device is further adapted such that, upon detecting that the field device has been switched on, said controlling device reads a field device feature from the field device feature carrier device and forwards said field device feature via the communication device to a measuring instrument access apparatus according to claim 1 and/or to the switching center device of the data network.

13. A switching center device, comprising:
a registration device;
an internal data interface configured for connecting with a private network;
an access interface receiving a connection request from a field device unit; and
a transmission mode switch-over device;
wherein the registration device is adapted to receive a network feature from a field device unit and establish a link to internal addressing information; and
wherein the transmission mode switching device is adapted to receive a switching command and switch a packet transmission mode on and/or off in accordance with the switching command.
